(19) United States
(12) Patent Application Publication
(10) Pub. No.: US 2014/0068139 A1
(43) Pub. Date: Mar. 6, 2014

(54) DATA TRANSFER SYSTEM AND METHOD

(71) Applicants: Michael J. Osborn, Hollis, NH (US); Mark D. Hummel, Franklin, MA (US); David E. Mayhew, Northborough, MA (US)

(72) Inventors: Michael J. Osborn, Hollis, NH (US); Mark D. Hummel, Franklin, MA (US); David E. Mayhew, Northborough, MA (US)

(73) Assignee: ADVANCED MICRO DEVICES, INC., Sunnyvale, CA (US)

(21) Appl. No.: 13/597,730

(22) Filed: Aug. 29, 2012

(51) Int. Cl. G06F 12/02; G06F 12/06

(52) U.S. Cl. 711/101; 711/173; 711/E12.084; 711/E12.007

(57) ABSTRACT

A system includes: a memory controller; a memory module with memory blocks in communication with the memory controller; an input controller in communication with the memory controller, where the memory controller notifies the input controller of a Next Address To Write corresponding with a Next Memory Block To Write in the memory module, each input block contains an address to a next block, and data is written to the is Memory Block To Write at the Next Address To Write in the memory module; and an output controller in communication with the other controllers, receives a starting address from the input controller of a first memory block to read from the memory module, a starting address is a Next Address To Read from a Next Memory Block To Read in the memory module, and the memory controller compares the Next Address To Write with the Next Address To Read.

### FIELD OF THE INVENTION

The present invention relates generally to data transfer with error detection and correction between devices, and more specifically, to a system and method for transferring data between devices which includes error correction code.

### BACKGROUND

Data centers are generally centralized facilities of computer systems that provide Internet and/or intranet services supporting businesses and organizations. A typical data center can house various types of electronic equipment, such as computers, domain name system (DNS) servers, network switches, routers, and data storage devices. A typical data center can have hundreds or thousands of interconnected servers communicating with each other and external devices via a switching architecture comprising the switches and routers. Conventional data centers can also be configured for virtualization, permitting servers or the like to share network interface cards (NICs), hard disk drives, or other hardware. A complex switch fabric can facilitate communications between the servers.

Computer systems store, manipulate and transfer data in memory devices such as, but not limited to, random access memory (RAM), dynamic random access memory (DRAM), static random access memory (SRAM), through-silicon via (TSV), etc. Random access memory (RAM) is a form of integrated circuits that allows stored data to be accessed in any order. DRAM reads data in bursts. SRAM is a type of semiconductor memory that must be periodically refreshed, using bistable latching circuitry to store each bit. Optimization of data transfer will improve speed, reliability and overall performance of computer systems whether they are located in data centers or in personal computing devices.

### BRIEF SUMMARY OF EMBODIMENTS

Accordingly, some embodiments of the present invention provide a data transfer system switching device for transferring data between various devices (e.g., those included in computer systems or networks) with improved speed. In at least one embodiment there is provided a data transfer system or switching device for transferring a data packet between locally or remotely located devices includes: a memory controller; a memory module, an input controller and an output controller. The memory module in communication with the memory controller is formatted with memory blocks for storing data. To transfer a data packet from a source to memory in the memory module, the input controller in communication with the memory controller receives the data packet from the source. The memory controller notifies the input controller of a next address to which to write (e.g., a “Next Address To Write” command or signal) corresponding to a memory block in which to write the next data (e.g., a “Next Memory Block To Write” command or signal) in the memory module. The input controller partitions the data packet into a linked list of input blocks where each input block corresponds in size to a memory block of memory in the memory module, and each of the linked list of input blocks contains an address to a next sequential block in the linked list. Data is written to the Next Block To Write memory block located at the Next Address To Write in the memory module.

In a further embodiment, there is provided an apparatus and method to transfer a data packet stored in the memory of the memory module to a destination device, the output controller in communication with the memory controller and the input controller, first receives a starting address from the input controller of a first memory block of the data packet to be read from the memory module, wherein the starting address is defined as a Next Address To Read from a Next Block To Read memory block in the memory module. In order to prevent underrun error, either the memory controller or the output controller compares the Next Address To Write with the Next Address To Read. If the addresses are equal then reading is paused. Otherwise reading and writing occur simultaneously.

In a further embodiment there is provided a method for transferring data packets between a source and a destination device includes first receiving and partitioning a data packet from a source into a linked list of input data blocks within input logic in preparation for transfer of the input data blocks to memory data blocks located in a memory. The linked list of input data blocks contains an address to a next sequential input data block in the linked list to complete the first data packet. The input data blocks are then written to the memory data blocks, wherein a Next Address To Write corresponds with a Next Memory Block To Write in the memory. Concurrently with the writing of the input data blocks, data can be transferred from the memory to a destination device. Thus, a comparison is made of the Next Address To Write with a Next Address To Read which corresponds to a Next Memory Block To Read of a second data packet stored in the memory. If the addresses are equal, then there is a pause in the reading of data. If the addresses are not equal, then data is read from the memory blocks in memory, a data packet to be read from memory is re-assembled and transferred to the destination device.

The above and other aspects of various embodiments of the present invention will become apparent in view of the following description, claims and drawings.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a data transfer system in accordance with the principles of the invention;

FIG. 2 is a flow chart diagram of a preferred method of inputting data from a source to a switching device in accordance with the principles of the invention; and

FIG. 3 is a flow chart diagram of a preferred method of outputting data from a switching device to a destination in accordance with the principles of the invention;

### DETAILED DESCRIPTION OF EMBODIMENTS

In the following description, specific details are set forth although it should be appreciated by one of ordinary skill that the systems and methods can be practiced without at least some of the details. In some instances, known features or processes are not described in detail so as not to obscure the present invention.

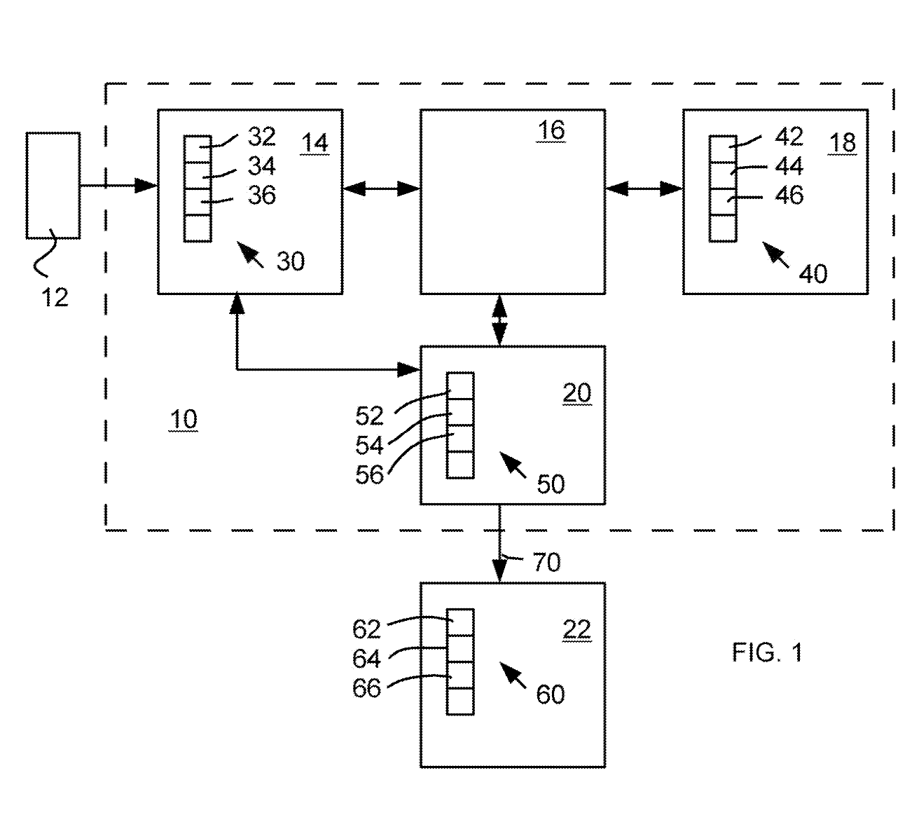

FIG. 1 is a block diagram of a preferred embodiment of a data transfer system or switching device 10 in accordance with the principles of the invention. The data transfer system 10 can be utilized in one example as a switching device within a computer or computer network, and includes an input control logic or input controller 14, a memory controller 16, a memory module 18 and an output control logic or output controller 20. The figure is completed with a source device 12 and a destination device 22. Both the one or more sources 12 and the one or more destination devices 22 can be resident within the computer system or they can be remote, such as in a remote server accessed over a LAN or the internet. Also, these devices can be any type of device such as computerized devices where data resides such as laptops, desktop computers, servers, hand-held devices, memory devices, etc.

The memory module 18 in this example is a memory chip, although any type of data transfer device may be applicable. It can contain non-volatile or volatile memory, for example, RAM, DRAM, SRAM, or TSV. The input control logic 14 and the output control logic 20 can be configured to include southbridge or related controllers for managing data transfers, and for performing other computer input/output (I/O) functions. The controllers 14 and 20 could also include an Ethernet device driver, PCIe connector, or other network connector for establishing a networking communication path.

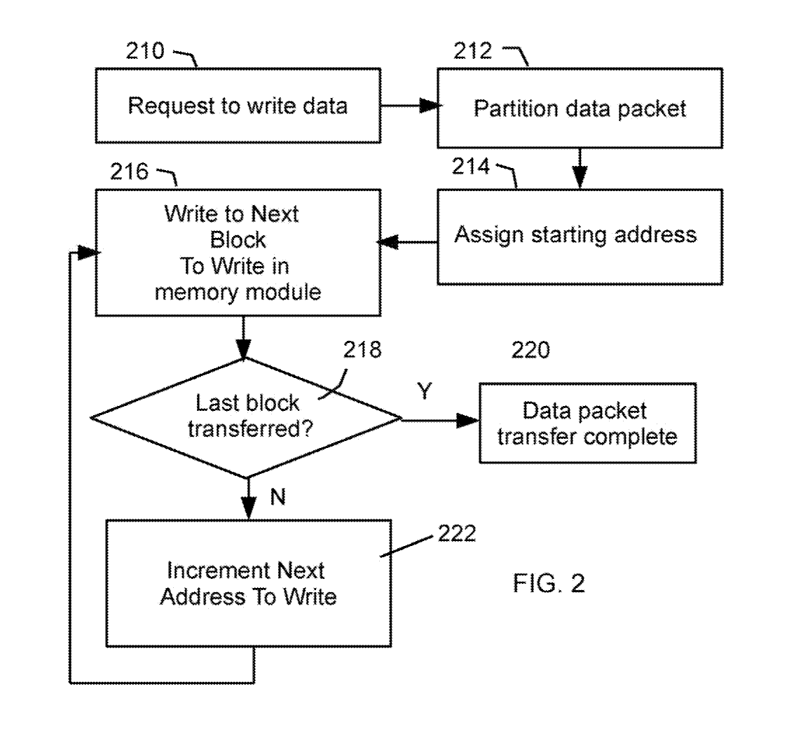

In a preferred method as outlined in the flow chart diagram of FIG. 2 and described in conjunction also with FIG. 1, a request to write (store) data into the memory module 18 is made in step 210 of FIG. 2 by a user or a computer for information resident in the one or more sources 12. The request may be just one step in a broader data transfer request, whereby one of the actions required is transferring data from the source 12 to the memory module 18. For example, the input controller 14 within a computer (or as in this example within the switch 10) will be instructed by a central processing unit to retrieve data from the one or more sources. The sources can be locally or remotely located and include, but are not limited to computers, servers, I/O devices, hard drives, portable devices like compact disks (CD) and digital versatile disks (DVD), and all memory storage devices for computerized systems.

The requested information is typically formatted for transfer as a data packet which is a formatted unit of data carried by a packet mode computer network, standard in today's operating systems and networks. A data packet consists of two kinds of data: control data and user data also known as payload data. The control data provides data that the network needs to deliver the payload data, for example, source and destination addresses, error detection codes like checksums, and sequencing information. Typically control data is found in packet headers and trailers, with payload data packed in between. Different communications protocols use different conventions for distinguishing between the elements and for formatting the data. In Binary Synchronous Transmission, the packet is formatted in 8-bit bytes, and special characters are used to delimit the different elements. Other protocols like Ethernet, establish the start of the header and data elements by their location relative to the start of the packet. Some protocols format the information at a bit level instead of a byte level.

Once the request has been received in step 210, the input control logic 14 in step 212 will partition the data packet or multiple data packets to be transferred from the source into a collect on of input blocks 32, 34, 36 . . . n, where n is a positive integer. In some embodiments the collection of input blocks 32, 34, 36, . . . , n may be in the form of a linked list. These input blocks are preferably predetermined as a fixed size, or an application-specific size. Alternately, the input data blocks may vary in size.

Definitions:

Next Block To Write=the memory block in memory currently having data written to it from the input controller

Next Address To Write=the address in memory of the Next Block To Write.

Next Block To Read=the memory block in memory currently having data read from it for transfer to the output controller and destination.

Next Address To Read=the address in memory of the Next Block To Read.

The input blocks 32, 34, 36 . . . n correspond to memory blocks 42, 44, 46 . . . n in the memory module 18. The memory controller 16 organizes and controls the memory blocks in the memory module 18, and the memory controller 16 will determine which memory blocks are available for storing the data packet. In step 214 either the input controller 14 or the memory controller 16 assigns a starting address deemed as a Next Address To Write associated with a Next Memory Block To Write located in the memory module.

When the transfer of data begins, the first input block 32 of data will be transferred to the first memory block 42 of the memory module 18. In this case, the starting address for transferring the data packet (step 214) will be the address in the memory module 18 of the first memory block 42 which is also labeled as the Next Address To Write. The Next Memory Block To Write will equal the first memory block 42.

After the write to memory block 42 is complete, a determination is made in step 218 whether memory block 42 was the last memory block to be written for the given transfer. If YES, then the data packet transfer is complete in step 220. If NO, then writing of another memory block in the collection (which in the embodiment described herein is arranged as a linked list) will continue in Step 216. As will be appreciated by those ordinary skill in the art, organizations of the collection of the data to be transferred other than a linked list can be selected. However, in certain embodiments a linked list may provide efficiencies in data transfer.

Once the transfer of data from the first input block 32 to the first memory block 42, (i.e. the Next Memory Block To Write), has been completed in step 216, then the address of the second memory block 44 in the memory module 18 will become the Next Address To Write and the second memory block 44 will equal the Next Memory Block To Write, whereby the data of input block 34 will be transferred to the second memory block 44. Either the input controller 14 or the memory controller 16 may set each Next Memory Address To Write corresponding to each Next Memory Block To Write. The process continues in this manner until all input blocks of the data packet have been transferred (step 218) and data packet transfer is complete (step 220), as flagged by an end block designation in the final input block of a given data packet.

In other words, the address of a memory block which is currently being written to is always defined as the Next Address To Write, and the memory block which is being currently written to is always defined as the Next Block To Write. The above definition is true even as the writing process continues through many different addresses in memory and their corresponding memory blocks.

A linked list is created in the input controller 14 when the input blocks 32, 34, 36 . . . n are linked for a given data packet and the input controller assigns pointers for each next memory block in the link. In other words, if a given data packet requires n memory blocks for data transfer, then the first memory block will contain a pointer to the location in memory of the 2nd memory block, the 2nd memory block will contain a pointer to the third memory block, etc. until an end indicator in the nth memory block signifies the end of the data packet. The pointers are included in the input blocks assembled in the input controller 14 and the pointers along with the data from the data packets are transferred to corresponding memory blocks in the memory, i.e. memory module 18.

Typically, multiple data packets will be transferred from the source and will be written sequentially to the memory module 18. Parallel writes may occur if desired. Also note that although the memory blocks 42, 44, 46 . . . n discussed above and in FIG. 1 are shown to be adjacent to one another, typically free memory blocks will be selected by the memory controller 16 that are scattered throughout the memory in the memory module 18 and selected based on availability and access.

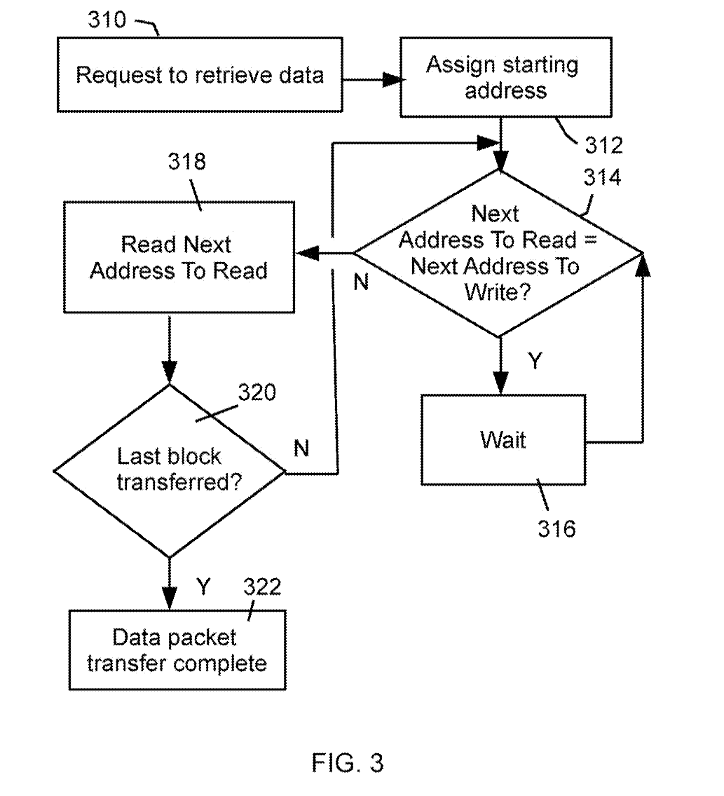

The process for requesting and retrieving data, e.g. a data packet, stored in the memory module 18 and transferring the data to the destination device 22 is described as follows in conjunction with FIGS. 1 and 3. Contemporaneous writing and reading of data in and out of the switching device 10 improves operational speed. Thus, a request to read (retrieve) data in step 310 may be made contemporaneous with, or at least overlapping with, the writing of data to the memory module 18 as described above. This read request is received from a user or computer by the output controller 20 for transfer of data from the memory module 18 in the local computer to a second location or destination device, either local or remote. As with the write request, the read request may be just one step in a broader data transfer request, whereby one of the actions required is transferring data from the memory module 18 to a destination device 22.

When the request to read data from the memory is received by the input controller 14 in step 310, the input controller 14 in communications with the memory controller 16 will notify the output controller 20 in step 312 of the starting address within the memory module 18 of the data packet to be retrieved from memory. Alternatively, the request to read could be received directly by the output controller 20. The starting address in memory is defined as the Next Address To Read which points to the Next Block To Read which in this case is memory block 42.

The memory blocks 42, 44, 46 . . . n in the memory module 18 correspond to output blocks 52, 54, 56 . . . n in the output controller 20 which, in turn, correspond to the destination blocks 52,54, 56 . . . n in the destination device 22. In other words, when the data transfer occurs, the data from memory block 42 will be copied and re-assembled into output block 52, then sent to destination block 62, the data from memory block 44 will be copied and re-assembled into output block 54, then sent to destination block 64, the data from memory block 46 will be copied and re-assembled into output block 56, then sent to destination block 66, etc.

Once the starting address is provided by the memory controller 16 to the input controller 14, then in step 314 a comparison is made by either the memory controller 16 or the output controller 20 to determine if reading and writing will occur at the same memory block. This condition is not desirable since it will cause a condition called data underrun error defined as a state in which a sending computer is transmitting characters slower than the receiving computer is reading them, in turn, reducing the bits per second (bps) rate and speed of the transmission.

In decision step 314 if the Next Address To Read equals the Next Address To Write, then the read will not take place. Rather the output controller 20 will wait in block 316 for a predetermined amount of time until it retries the test of step 314.

If the Next Address To Read does not equal the Next Address To Write in step 314, then the output controller 20 will read the Next Block To Read associated with the Next Address To Read. In this case, memory block 42 will be read and copied to output block 52 in the output controller 20. As the output controller 20 continues to read and copy memory blocks, it will re-assemble the memory blocks to complete the data packet that is being retrieved from memory. Re-assembly of memory blocks of a data packet could also be done by the memory controller 16.

The linked list of memory blocks for the data packet to be retrieved from storage in the memory module 18 is re-assembled within the output controller 20. The memory blocks 42, 44, 46 . . . n in the memory module 18 correspond to output blocks 52, 54, 56 . . . n in the output controller 20. When the first memory block 42 is read, the address of the next memory block to be read in the sequence will also be read by the output controller 20. After the transfer of data from memory block 42 to output block 52 is complete, then the second memory block 44 in the sequence is read and copied to output block 54. After the transfer of data from memory block 44 to output block 54 is complete, then the third memory block 46 in the sequence is read and copied to output block 56. When the output controller 20 reads the end flag for the nth memory block in the sequence, then the last block of the data packet is copied and the linked list is completely re-assembled as output blocks 52, 54, 56 . . . n. The output controller 20 then transfers the output blocks to the destination blocks 62, 64, 66 . . . n in the destination device 22.

At any time during the read transfer of data via the output controller 20 from the memory module 18 to the destination device 22, if an attempt is made to read and write from the same memory block, then the output controller 20 will delay reading that same memory block until the write operation by the input controller 24 is complete for that given same memory block in the memory module 18. Alternatively to waiting, the read operation could read other data such as another data packet or another memory block during the wait period, although it can't read another memory block from the same data packet. The read operation could postpone the read operation for a given period of time in order to complete reading another data packet.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

What is claimed is:

1. A data transfer system for transferring a data packet between a source device and a destination device, the data transfer system comprising:
a memory controller;
a memory module in communication with the memory controller, the memory module formatted with memory blocks for storing data;
an input controller in communication with the memory controller, the input controller
(1) receiving the data packet from the source,
(2) communicating to the memory controller in preparation for transferring the data packet to the memory module, wherein the memory controller notifies the input controller of a next available address to write corresponding to a next available memory block in the memory module, and
(3) partitioning the data packet into a collection of input blocks where each input block corresponds in size to a memory block and each of the collection of input blocks contains an address to a next sequential block, and wherein data is currently being written to the next available address to write corresponding to the next available memory block to write in the memory module; and
an output controller in communication with the memory controller and the input controller, receiving a starting address from the input controller of a first memory block of a data packet to be read from the memory module, wherein the starting address is defined as a next available address to read from a next available memory block to read in the memory module,
wherein the memory controller compares the Next Address To Write with the Next Address To Read.

2. The data transfer system of claim 1, wherein the next available memory block to write is defined as a memory block in memory currently having data written from the input controller, the next available address to write is defined as the address in memory of the next available memory block to write, the next available memory block to read is defined as a memory block in memory currently having data read from the output controller, and the next available address to read is defined as an address in memory of the next available memory block to read.

3. The data transfer system of claim 1 wherein the collection of input blocks comprises a linked list of input blocks.

4. The data transfer system of claim 1 wherein the memory controller compares the next available address to write with the next available address to read and if the next available address to write does not equal the next available address to read, then the memory controller instructs the output controller to re-assemble and transfer the data packet to be read from the memory module to the destination device.

5. The data, transfer system of claim 1 wherein the memory controller compares the next available address to write with the next available address to read and if the next available address to write equals the next available address to read, then the memory controller instructs the output controller to wait.

6. The data transfer system of claim 1 wherein the memory controller compares the next available address to write with the next available address to read and if the next available address to write equals the next available address to read, then the memory controller instructs the output controller to read another memory block located at another address in the memory module.

7. The data transfer system of claim 1 wherein the memory blocks are a predetermined fixed size.

8. The data transfer system of claim 1 wherein the memory blocks vary in size.

9. The data transfer system of claim 1 wherein the memory module is selected from the group consisting of TSV, DRAM, SRAM and CAM.

10. The data transfer system of claim 1 wherein the data packet includes control data comprising source addresses, destination addresses, error detection codes, checksums, and sequencing information.

11. A switching system for transferring a data packet between a source device and a destination device, the switching system comprising:
a memory controller;
a memory module in communication with the memory controller, the memory module formatted with memory blocks for storing data;
an input controller in communication with the memory controller, the input controller
(1) receiving the data packet from the source,
(2) communicating to the memory controller in preparation for transferring the data packet to the memory module, wherein the memory controller notifies the input controller of a next available address to write corresponding with a next available memory block to write data in the memory module, and
(3) partitioning the data packet into a linked list of input blocks where each input block corresponds in size to a memory block and each of the linked list of input blocks contains an address to a next sequential block in the linked list, and wherein data is currently being written to the next available memory block to write located at the next available address to write in the memory module; and
an output controller in communication with the memory controller and the input controller, receiving a starting address from the input controller of a first memory block of a data packet to be read from the memory module, wherein the starting address is defined as a next available address to read from a next available memory block to read in the memory module, the output controller comparing the next available address to write with the next available address to read.

12. The switching system of claim 11 wherein the output controller compares the next available address to write with the next available address to read and if the next available address to write does not equal the next available address to read, then the memory controller instructs the output controller to re-assemble and transfer the data packet to be read from the memory module to the destination device.

13. The switching system of claim 11 wherein the output controller compares the next available address to write with the next available address to read and if the next available address to write equals the next available address to read, then the memory controller instructs the output controller to wait.

14. The switching system of claim 11 wherein the output controller compares the next available address to write with the next available address to read and if the next available address to write equals the next available address to read, then the memory controller instructs the output controller to read another memory block located at another address in the memory module.

15. The switching system of claim 11 wherein the memory blocks are a predetermined fixed size.

16. The switching system of claim 11 wherein the memory blocks vary in size.

17. The switching system of claim 11 wherein the memory module is selected from the group consisting of TSV, DRAM, SRAM and CAM.

18. The switching system of claim 11 wherein the data packet includes control data comprising source addresses, destination addresses, error detection codes, checksums, and sequencing information.

19. A method for transferring data packets between a source and a destination device, the method comprising the steps of:
receiving and partitioning a first data packet into a linked list of input data blocks within input logic in preparation for transfer of the input data blocks to memory data blocks located in a memory, wherein each of the linked list of input data blocks contains an address to a next sequential input data block in the linked list to complete the first data packet;
writing the input data blocks to the memory data blocks, wherein a next available address to write corresponds with a next available memory block to write in the memory; and
concurrently with the writing of the input data blocks, comparing the next available address to write with a next available address to read corresponding to a next available memory block to read of a second data packet stored in the memory.

20. The data transfer method of claim 19, further comprising the step of:
if the next available address to write does not equal the next available address to read then reassembling and transferring the second data packet to the destination device.

21. The data transfer method of claim 19, further comprising the step of:
if the next available address to write equals the next available address to read then waiting until the next available address to write does not equal the next available address to read before re-assembling and transferring the second data packet to the destination device.

22. The data transfer method of claim 19, further comprising the step of:
if the next available address to write equals the next available address to read then selecting another address to read.

23. The data transfer method of claim 19 wherein the data packet includes control data comprising source addresses, destination addresses, error detection codes, checksums, and sequencing information.
